(19) United States
(12) Patent Application Publication
(10) Pub. No.: US 2009/0073584 A1
(43) Pub. Date: Mar. 19, 2009

(54) LENS POSITION CONTROL DEVICE AND METHOD

(75) Inventor: Chan Woo Park, Gyeonggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 12/015,968

(22) Filed: Jan. 17, 2008

(30) Foreign Application Priority Data
Sep. 18, 2007 (KR) 10-2007-0094663

(51) Int. Cl. G02B 7/02

(52) U.S. Cl. 359/823

(57) ABSTRACT

Provided is a lens position control device including a driving frequency generating unit that generates a driving frequency for moving the position of a lens and a driving frequency for reducing the moving speed of the lens to re-move the lens in the reverse direction to the moving direction of the lens after the lens is stopped; a lens control unit that is connected to the driving frequency generating unit and is driven by the generated driving frequency so as to move the lens; and a lens position detecting unit that is connected to the driving frequency generating unit and detects the position of the lens to deliver to the driving frequency generating unit.

### CROSS-REFERENCE TO RELATED APPLICATIONS

This application claims the benefit of Korean Patent Application No. 10-2007-0094663 filed with the Korea Intellectual Property Office on Sep. 18, 2007, the disclosure of which is incorporated herein by reference.

### BACKGROUND OF THE INVENTION

1. Field of the Invention

The present invention relates to a lens position control device and method.

2. Description of the Related Art

Recently, as a camera module used in mobile terminals is considered as an essential component of mobile terminals, the importance of additional functions of the camera modules is increasing. Accordingly, to implement an auto-focusing function which is commonly used among the additional functions used for mobile terminals, the position of a lens should be vertically moved.

To move the position of the lens of the camera module, a driving element such as an actuator is used. Such a driving element moves the lens to a target position where the lens is to be moved. However, although the power supply is cut off after the lens is moved, the lens is further moved by a predetermined distance. In this case, the focus of an image is not accurately adjusted.

Hereinafter, a conventional lens position control device and method having the above-described problem will be described with reference to FIGS. 1 to 5.

FIG. 1 is a block diagram of a conventional lens position control device, and FIG. 2 is a flow chart sequentially showing a conventional lens position control method.

First, as shown in FIG. 1, the conventional lens position control device includes a driving frequency generating unit 10, an actuator 20, a lens 30, and a lens position detecting unit 40. The conventional lens position control device moves the lens 30 to a target position for adjusting the focus of an image.

The driving frequency generating unit 10, which is connected to the actuator 20 and the lens position detecting unit 40, generates first and second driving frequencies F1 and F2 for moving the lens 30 in the upward and downward directions, respectively, and then supplies the first and second driving frequencies F1 and F2 to the actuator 20. The driving frequency generating unit 10 receives a detection signal P delivered from the lens position detecting unit 40 and selects and outputs the first or second driving frequency F1 or F2 for moving the lens 30. When the lens 30 is moved to the target position for adjusting the focus, the driving frequency generating unit 10 does not output the first or second driving frequency F1 or F2.

The actuator 20 is connected to the driving frequency generating unit 10 and the lens 30 and is driven by the first or second driving frequency F1 or F2 supplied from the driving frequency generating unit 10 so as to vertically move the lens 30. Then, the lens 30 is moved to the target position.

The lens 30 is connected to the actuator 20 and is moved by the actuator 20 so as to adjust the focus of an image. The position of the lens 30 is detected by the lens position detecting unit 40, and the lens 30 is vertically moved by the actuator 20 until the lens 30 is moved to the target position.

The lens position detecting unit 40 is connected to the driving frequency generating unit 10 and is positioned adjacent to the lens 30. The lens position detecting unit 40 detects the current position of the lens 30 and then delivers the detection signal P to the driving frequency generating unit 10.

The conventional lens position control method using the conventional lens position control device is performed as follows. First, as shown in FIG. 2, a target position to which the lens 30 is to be moved to adjust the focus of an image is set (step S110).

When the target position is set, the target position is compared with the current position of the lens 30 (step S120). At this time, when it is judged that the current position is lower than the target position, the driving frequency generating section 10 generates the second driving frequency F2 for moving the lens 30 in the upward direction and then supplies the second driving frequency F2 to the actuator 20 so as to move the lens 30 in the upward direction (step S130).

While the lens 30 is moved in the upward direction in step S130, the current position of the lens 30 is detected and is continuously compared with the target position. When the current position of the lens 30 is identical to the target position, the supplying of the second driving frequency F2 is blocked to stop the actuator 20. Then, the lens 20 is stopped from being moved.

When it is judged in step S120 that the current position of the lens 30 is higher than the target position, the first driving frequency F1 for moving the lens 30 in the downward direction is generated and supplied to the actuator 20 so as to move the lens 30 in the downward direction (step S150).

While the lens 30 is moved in the downward direction in step S150, the current position of the lens 30 is detected and is continuously compared with the target position. When the current position of the lens 30 is identical to the target position, the supplying of the first driving frequency F1 is blocked to stop the actuator 20. Then, the lens 30 is stopped from being moved.

In the conventional lens position control device and method, the first or second driving frequency F1 or F2 generated from the driving frequency generating unit 10 is supplied to the actuator 20 so as to move the lens 30 to the target position, thereby adjusting the focus of an image.

However, the conventional lens position control device and method has the following problems.

In the conventional lens position control device and method, while the lens 30 is moved from the current position to the target position, the first or second driving frequency with a constant magnitude is supplied to the actuator 20. When the lens 30 reaches the target position, the supplying of the first or second driving frequency F1 or F2 is blocked. At this time, the actuator 20 is not stopped at the same time when the supplying of the first or second driving frequency F1 or F2 is blocked, but further moves the lens 30 by a predetermined distance in the moving direction because of the force of the actuator 20 which has moved the lens 30. Then, the position of the lens 30 deviates from the target position, which makes it difficult to accurately adjust the focus of an image.

FIGS. 3 and 4 are timing diagrams showing a state where the lens is moved by the conventional lens position control device. FIG. 3 shows a state that the lens 30 is moved in the downward direction by the supplying of the second driving frequency F2. As shown in FIG. 3, when the position of the lens 30 is higher than the target position, the first driving frequency F1 is supplied to move the lens 30 downward. At a point of time ‘S’ where the current position is the same as the target position, the supplying of the first driving frequency F1 is blocked so as to stop the operation of the actuator 20. At this time, the actuator 20 is not stopped at the same time when the supplying of the first driving frequency F1 is blocked, but further moves the lens 30 by a predetermined distance ‘e0’ from the target position in the moving direction because of the force of the actuator 20 which has moved the lens 30. Then, the position of the lens 30 deviates from the target position, and the focus of an image is not accurately adjusted.

Further, as shown in FIG. 4, when the current position of the lens 30 is lower than the target position, the lens 30 is moved upward by the second driving frequency F2. At a point of time ‘S’ where the current position becomes the same as the target position, the supplying of the second driving frequency F2 is blocked to stop the operation of the actuator 20. At this time, the actuator 20 is not immediately stopped, but further moves the lens 30 by a predetermined distance ‘e0’ from the target position in the moving direction. Then, the position of the lens 30 deviates from the target position, and the focus of an image is not accurately adjusted.

FIG. 5 is a diagram showing a movement error of the lens 30. As shown in FIG. 5, the lens 30 moved by the second driving frequency F2 in the direction of an arrow ‘a’ is not stopped at the target position, but is further moved upward by the distance ‘+e0’. Further, the lens 30 moved by the first driving frequency F1 in the direction of an arrow ‘b’ is not stopped at the target position, but is further moved downward by the distance ‘−e0’. That is, an error of 2e0 occurs in the upward and downward direction on the basis of the target position. Accordingly, the focus of an image is not accurately adjusted, so that the sharpness of the image is degraded. Then, the reliability of the lens position control device is degraded.

### SUMMARY OF THE INVENTION

An advantage of the present invention is that it provides a lens position control device and method which reduces the moving speed of a lens to re-move the lens in the reverse direction to the moving direction of the lens when the current position of the lens deviates from a target position after the lens is moved to the target position at constant speed, thereby accurately moving the lens to the target position.

Additional aspects and advantages of the present general inventive concept will be set forth in part in the description which follows and, in part, will be obvious from the description, or may be learned by practice of the general inventive concept.

According to an aspect of the invention, a lens position control device comprises a driving frequency generating unit that generates a driving frequency for moving the position of a lens and a driving frequency for reducing the moving speed of the lens to re-move the lens in the reverse direction to the moving direction of the lens after the lens is stopped; a lens control unit that is connected to the driving frequency generating unit and is driven by the generated driving frequency so as to move the lens; and a lens position detecting unit that is connected to the driving frequency generating unit and detects the position of the lens to deliver to the driving frequency generating unit.

Preferably, the driving frequency generating unit includes a driving frequency control section which is connected to the lens position detecting unit and generates a control signal for generating the driving frequency; and a driving frequency generating section which is connected to the driving frequency control section and the lens control unit and is controlled by the control signal output from the driving frequency control section so as to generate a driving frequency.

Preferably, when the current position of the lens detected by the lens position detecting unit deviates from the target position, to which the lens is to be moved, after the lens is moved, the driving frequency control section outputs a control signal for generating a driving frequency for reducing the moving speed of the lens to re-remove the lens in the reverse direction to the moving direction of the lens. The driving frequency control section reduces the moving speed of the lens by reducing any one selected from the magnitude of the driving frequency, a duty width, and the frequency.

Preferably, when the current position of the lens detected by the lens position detecting unit deviates from the target position, the driving frequency control section outputs a control signal for reducing the magnitude of the driving frequency at a ratio selected from 1/2, 1/3, 1/4, and 1/5.

According to another aspect of the invention, a lens position control method comprises the steps of: (a) setting a target position to which a lens is to be moved; (b) judging whether the target position is higher than the current position of the lens or not; (c) when it is judged that the target position is higher than the current position, generating a driving frequency for moving the lens in an upward direction; (d) after the lens is moved to the target position, comparing the target position with the current position of the lens; (e) when the current position is identical to the target position, judging whether the lens is positioned within a preset limit region or not; and (f) when it is not judged that the lens is positioned within the limit region, generating a driving frequency for reducing the moving speed of the lens such that the process is fed back to step (a) to re-move the position of the lens.

Preferably, when it is judged in step (b) that the target position is lower than the current position, a driving frequency for moving the lens in the downward direction is generated. Further, when it is judged in step (d) that the current position is different from the target position, the process is fed back to step (b).

Preferably, in step (f), the magnitude of the driving frequency, a duty width, or the frequency is reduced so as to reduce the moving speed of the lens. Further, the magnitude of the driving frequency is reduced at a ratio selected from 1/2, 1/3, 1/4, and 1/5.

Preferably, when it is judged in step (e) that the lens is positioned within the limit region, the lens is stopped.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional lens position control device;

FIG. 2 is a flow chart sequentially showing a conventional lens position control method;

FIGS. 3 and 4 are timing diagrams showing a state where a lens is moved by the conventional lens position control device;

FIG. 5 is a diagram showing a movement error of the lens;

FIG. 6 is a block diagram of a lens position control device according to the invention;

FIGS. 7 and 8 are timing diagrams showing a state where a lens is moved by the lens position control device according to the invention;

FIG. 9 is a diagram showing a state where the lens is re-moved by the lens position control device according to the invention; and

FIG. 10 is a flow chart sequentially showing a lens position control method according to the invention.

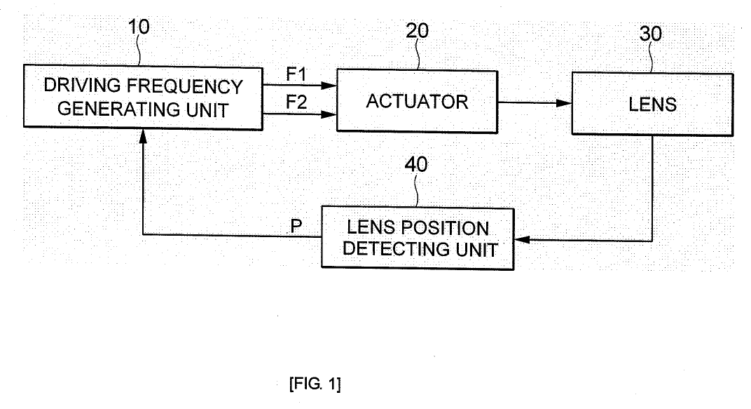

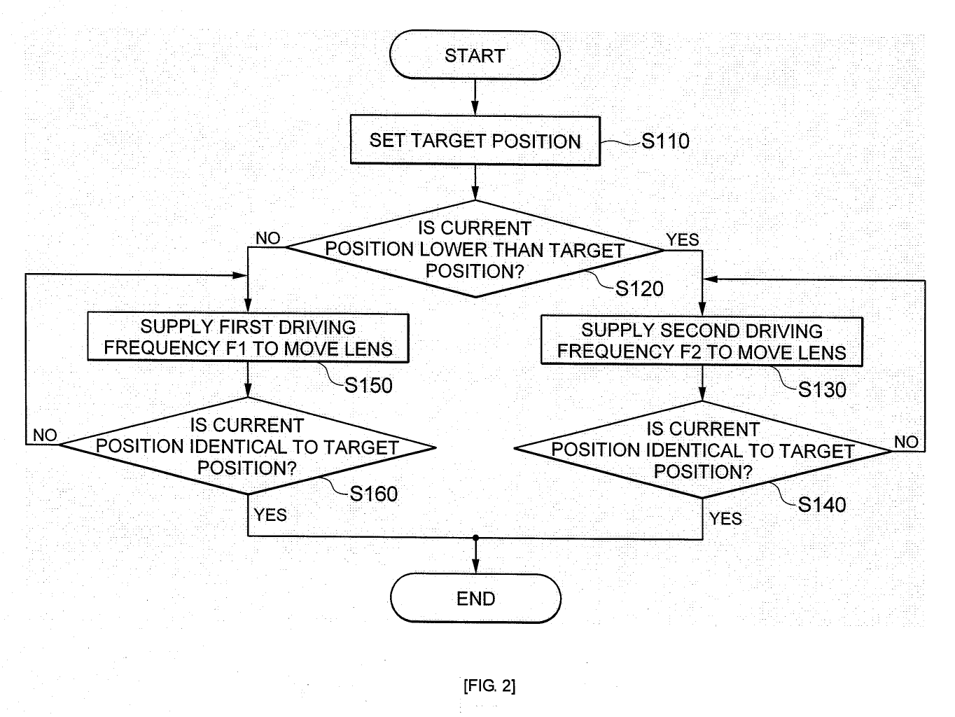

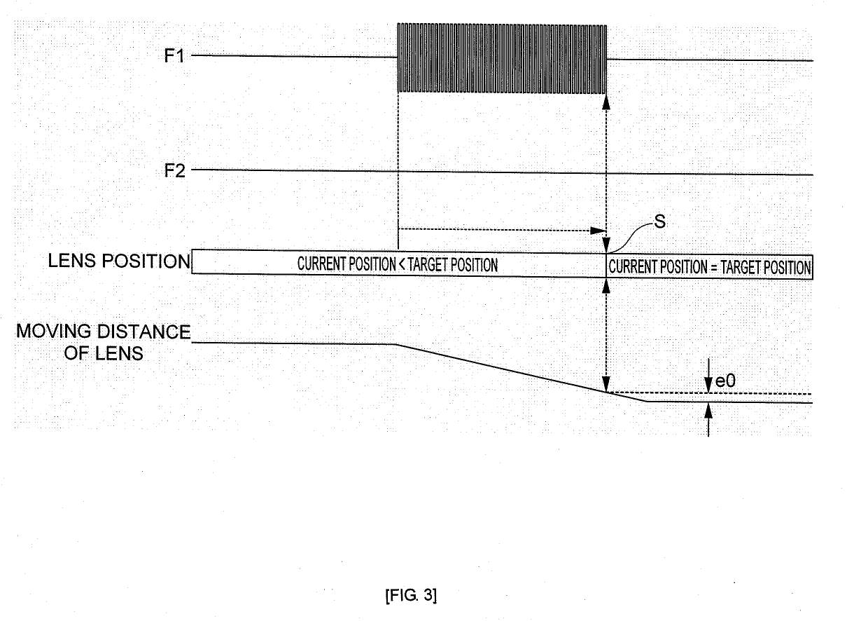

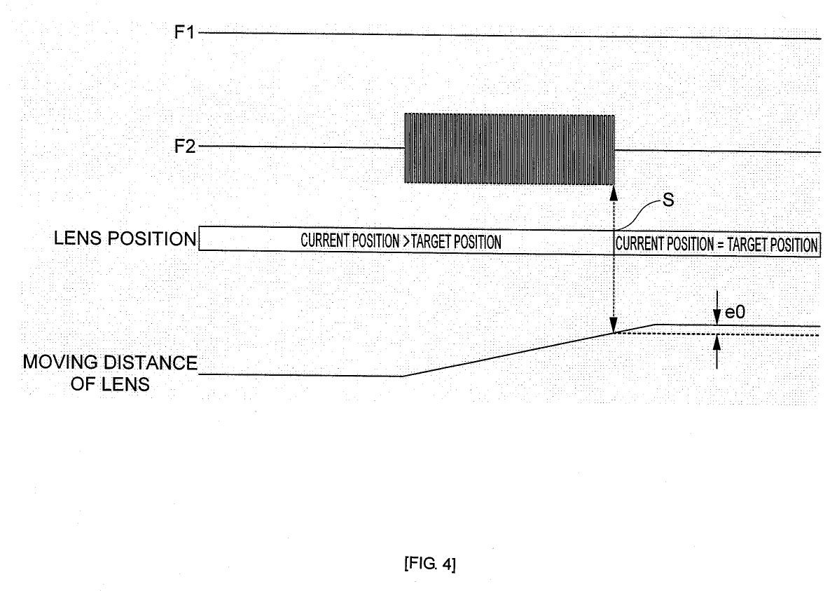

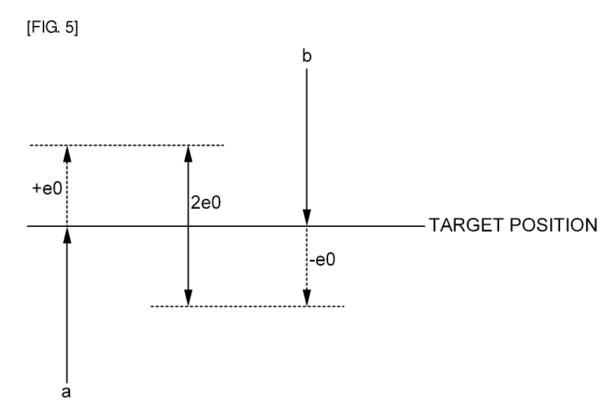

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Lens Position Control Device

Hereinafter, a lens position control device according to the invention will be described in detail with reference to the accompanying drawings.

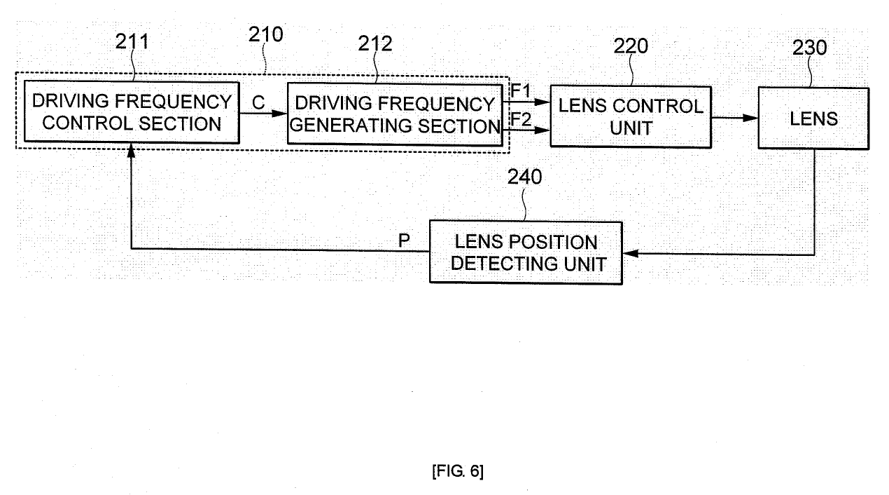

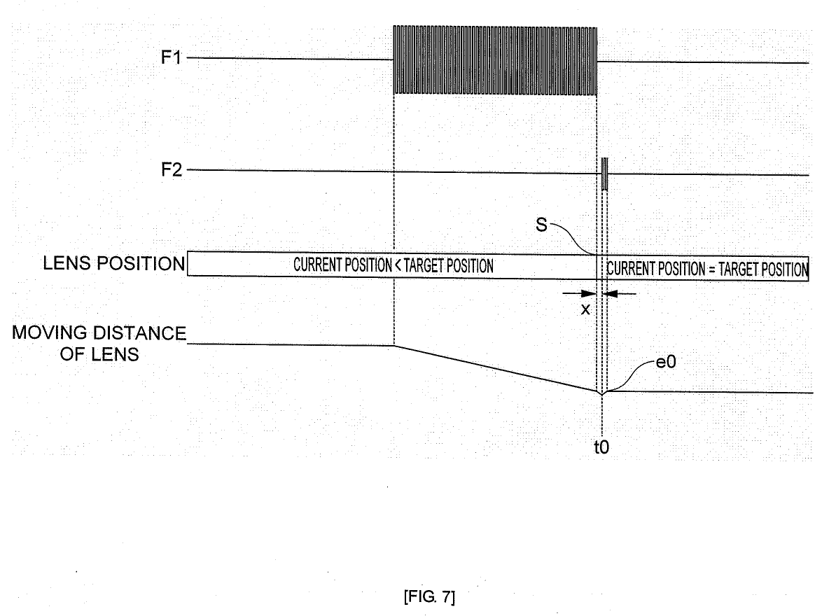

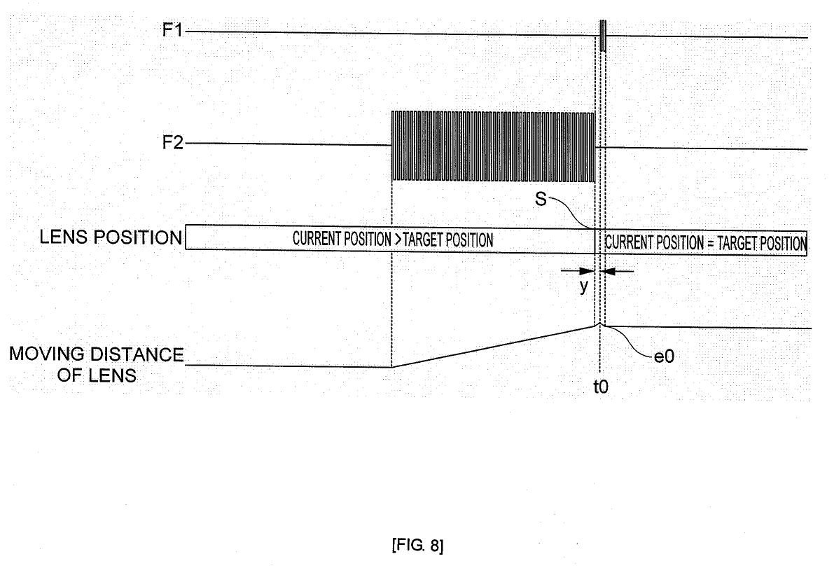

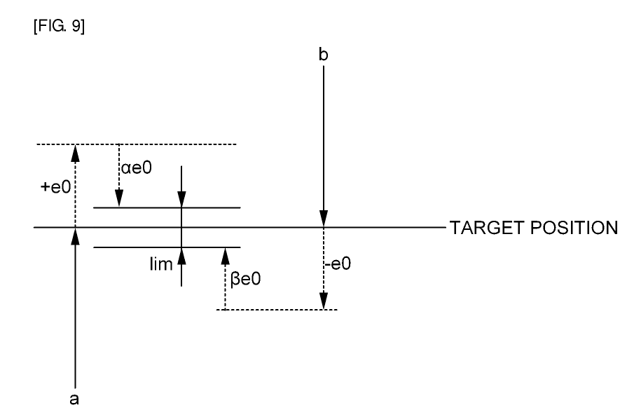

FIG. 6 is a block diagram of a lens position control device according to the invention. FIGS. 7 and 8 are timing diagrams showing a state where a lens is moved by the lens position control device according to the invention. FIG. 9 is a diagram showing a state where the lens is re-moved by the lens position control device according to the invention.

As shown in FIG. 6, the lens position control device according to the invention includes a driving frequency generating unit 210, a lens control unit 220, a lens 230, and a lens position detecting unit 240. The lens position control device moves the lens 230 to a target position at a constant speed, and then reduces the moving speed of the lens 230 so as to remove the lens 230 in the reverse direction to the moving direction of the lens 230, thereby accurately adjusting the focus of an image.

The driving frequency generating unit 210 is composed of a driving frequency control section 211 and a driving frequency generating section 212 and is connected to the lens control unit 220 and the lens position detecting unit 240. The driving frequency generating unit 210 generates a first or second driving frequency F1 or F2 for moving the position of the lens 230. Further, the driving frequency generating unit 210 generates a first or second driving frequency F1 or F2 for reducing the moving speed of the lens 230 so as to re-move the lens 230 in the reverse direction to the moving direction after the lens 230 is stopped.

The driving frequency control section 211, which is connected to the lens position detecting unit 240 and the driving frequency generating section 212, receives a detection signal P, in which the position of the lens 230 is detected, from the lens position detecting unit 240, and then outputs a control signal S for controlling the first or second driving frequency F1 or F2 for moving the lens 230 to a target position.

Further, the driving frequency generating section 212, which is connected to the driving frequency control section 211 and the lens control unit 220, is controlled by the control signal C output from the driving frequency control section 211 so as to generate the first driving frequency F1 for moving the lens 230 in a downward direction or the second driving frequency F2 for moving the lens 230 in an upward direction. Then, the driving frequency generating section 212 supplies the first or second driving frequency F1 or F2 to the lens control unit 220.

The driving frequency control section 211 sets a target position for adjusting the focus of an image and compares the target position with the current position of the lens 230. When the target position is higher than the current position of the lens 230, the driving frequency control section 211 outputs a control signal C for generating the second driving frequency F2 for moving the lens 230 in the upward direction, and then delivers the control signal C to the driving frequency generating section 212. When the target position is lower than the current position of the lens 230, the driving frequency control section 211 outputs a control signal C for generating the first driving frequency F1 for moving the lens 230 in the downward direction, and then delivers the control signal C to the driving frequency generating section 212.

After the lens 230 is moved toward the target position, and when the current position of the lens 230 detected by the lens position detecting unit 240 deviates from the target position to which the lens 230 is to be moved, the driving frequency control section 211 outputs a control signal C for controlling the first or second driving frequency F1 or F2 so as to reduce the moving speed of the lens 230.

When the driving frequency control section 211 reduces the moving speed of the lens 230, any one selected from the magnitude of the first or second frequency F1 or F2, a duty width, and the frequency may be reduced. If the driving frequency control section 211 reduces the magnitude of the first or second frequency F1 or F2 so as to reduce the moving speed, the magnitude of the first and second driving frequencies F1 and F2 is reduced at any one ratio selected from 1/2, 1/3, 1/4 and 1/5.

The lens control unit 220, which is connected to the driving frequency generating unit 210 and the lens 230, receives the first or second driving frequency F1 or F2 generated from the driving frequency generating section 212 of the driving frequency generating unit 210 so as to move the lens 230. When the first driving frequency F1 is supplied, the lens control unit 220 moves the lens 230 in the downward direction. When the second driving frequency F2 is supplied, the lens control unit 220 moves the lens 230 in the upward direction. The lens control unit 220 is a driving element for moving the lens 230 in the upward and downward direction. As for the lens control unit 220, an actuator is mainly used. Depending on users, a DC motor, an AC motor, a step motor and so on may be used.

The lens 230 is connected to the lens control unit 220 and is moved upward or downward by the lens control unit 220 so as to adjust the focus of an image. The lens position detecting unit 240 is connected to the driving frequency control section 211 of the driving frequency generating unit 210 and is positioned adjacent to the lens 230. The lens position detecting unit 240 detects the position of the lens 230 and delivers the detection signal P to the driving frequency control section 211.

As shown in FIG. 7, when the current position of the lens 230 is higher than the target position, the lens position control device generates the first driving frequency F1 to deliver to the lens control unit 220, and the lens control unit 220 is driven by the first driving frequency F1 so as to move the lens 230 in the downward direction.

The first driving frequency F1 is continuously supplied until the lens position detecting unit 240 detects that the lens 230 is moved to the same position as the target position at a point of time ‘S’. After the point of time ‘S’, the lens control unit 220 is driven by the force, which moved the lens 230, so as to further move the lens in the moving direction by a predetermined distance ‘x’. At this time, the lens position detecting unit 240 detects it, and the driving frequency control section 211 receiving the detection signal P generates a control signal C for generating the second driving frequency F2 for moving the lens 230 in the reverse direction to the moving direction. In particular, the driving frequency control section 211 generates a control signal C for reducing the magnitude of the second driving frequency F2 to 1/2 such that the moving speed is reduced to minutely move the lens 230. Here, the magnitude of the second driving frequency F2 is reduced at a ratio, which is previously set by a user. In this case, the ratio is selected from 1/2, 1/3, 1/4, and 1/5.

The driving frequency generating section 212 receiving the control signal C for reducing the magnitude of the second driving frequency F2 generates a second driving frequency F2 with a half smaller magnitude than that of the first driving frequency F1 and then supplies the second driving frequency F2 to the lens control unit 220. The lens control unit 220 receiving the second driving frequency F2 re-moves the lens 230 in the reverse direction of the moving direction at speed reduced by the second driving frequency F2, thereby moving the lens 230 to the target position.

As shown in FIG. 8, when the current position of the lens 230 is lower than the target position, the lens position control device generates the second driving frequency F2 to deliver to the lens control unit 220. The lens control unit 220 is driven by the second driving frequency F2 so as to move the lens 230 in the upward direction.

The second driving frequency F2 is continuously supplied until the lens position detecting unit 240 detects that the lens 230 is moved to the same position as the target position at a point of time ‘S’. After the point of time ‘S’, the lens control unit 220 is driven by the force which moved the lens 230 so as to further move the lens 230 in the moving direction by a predetermined distance ‘Y’. At this time, the lens position detecting unit 240 detects it, and the driving frequency control section 211 receiving the detection signal P generates a control signal C for generating the first driving frequency F1 for moving the lens 230 in the reverse direction to the moving direction. In particular, the driving frequency control section 211 generates a control signal S for reducing the magnitude of the first driving frequency F1 to 1/2 so as to minutely move the lens 230.

The driving frequency generating section 212 receiving the control signal C for reducing the magnitude of the first driving frequency F1 generates a first driving frequency F1 of which the magnitude is half smaller than that of the second driving frequency F2 and then supplies the first driving frequency F1 to the lens control unit 220. The lens control unit 220 receiving the first driving frequency F1 re-moves the lens 230 in the reverse direction to the moving direction at speed reduced by the first driving frequency F1, thereby moving the lens 230 to the target position.

As shown in FIG. 9, when the position of the lens 230 deviates from the target position after the lens 230 is moved upward along an arrow ‘a’ by the second driving frequency F2, the lens position control device generates the first driving frequency F1 having a smaller magnitude than that of the second driving frequency F2 so as to drive the lens 230. Then, the lens 230 is moved by a distance ‘αe0’ so as to be positioned adjacent to the target position. In a reverse case, the lens 230 is removed by a distance ‘βe0’ to as to be positioned adjacent to the target position. Therefore, it is possible to adjust the focus of an image as accurately as possible. At this time, when the lens 230 is positioned within a preset limit region after the lens 230 is moved in the reverse direction to the moving direction, the lens 230 is stopped. When the position of the lens 230 deviates from the limit region even after being re-moved, the lens position control device further reduces the magnitude of the first or second driving frequency F1 or F2 so as to re-move the lens 230 in the reverse direction to the moving direction, thereby positioning the lens 230 within the limit region.

The lens position control device moves the lens 230 to the target position and then reduces the moving speed of the lens 230 so as to re-move the lens 230 by a predetermined distance in the reverse direction to the moving direction of the lens 230. Then, the lens 230 is positioned within the limit region ‘lim’ where the focus of an image is accurately adjusted. As the focus of the image is accurately adjusted, the sharpness of the image is enhanced, which makes it possible to enhance the reliability of the lens position control device.

Lens Position Control Method

Hereinafter, a lens position control method according to the invention will be described in detail with reference to the accompanying drawings.

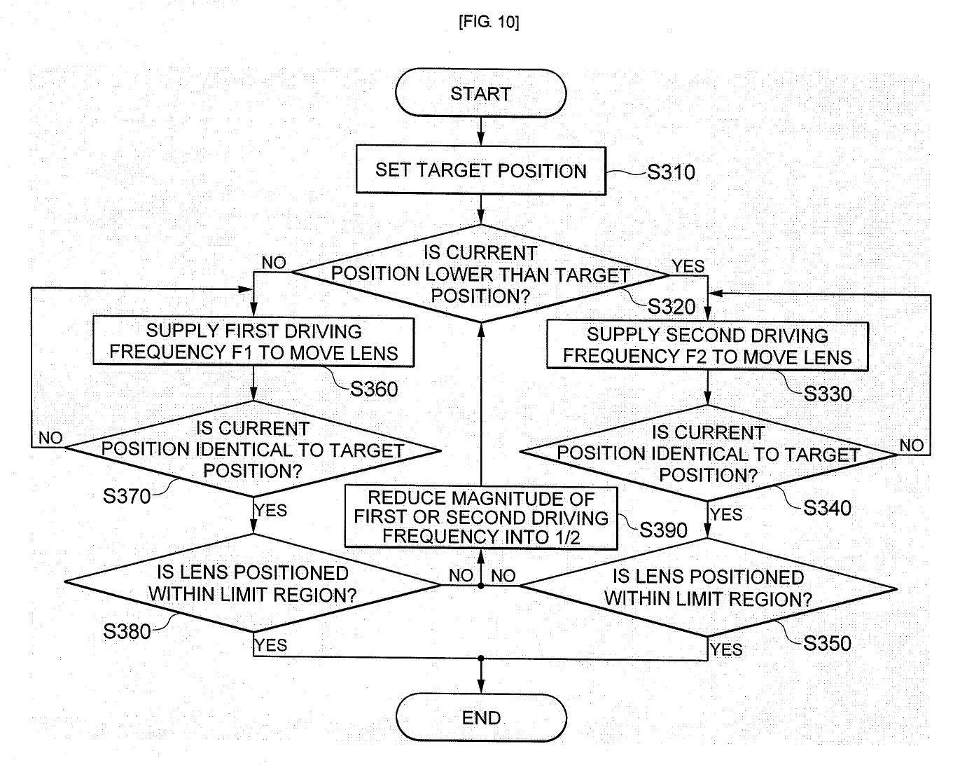

FIG. 10 is a flow chart sequentially showing a lens position control method according to the invention.

First, as shown in FIG. 10, a target position of the lens 230 for adjusting the focus of an image is set (step S310).

After the target position is set, the target position is compared with the current position of the lens 230 so as to judge whether the current position is higher or lower than the target position (step S320). At this time, when it is judged in step S320 that the current position is lower than the target position, a second driving frequency F2 for moving the lens 230 upward is supplied to the lens control unit 220 so as to move the lens 230 toward the target position (step S330).

After the lens 230 is moved, it is continuously detected whether the lens 230 is positioned at a position having the same height as the target position (step S340). When the current position of the lens 230 is identical to the target position, it is judged whether the lens 230 is positioned in a limit region ‘lim’ or not (step S350).

When it is not judged in step S350 that the lens 230 is positioned within the limit region, the moving speed of the lens 230 is reduced, and the process is fed back to step S320. Then, steps 320 to 350 are repeated. To reduce the moving speed of the lens 230, any one selected from the magnitude of a first or second driving frequency F1 or F2, a duty width, and the frequency is reduced. When the magnitude of the first driving frequency F1 is reduced, it is preferable that the magnitude is reduced at a ratio selected from 1/2, 1/3, 1/4, and 1/5.

After the process is fed back from step S350, and when it is judged in step S320 that the current position of the lens 230 is higher than the target position, the first driving frequency F1 of which the magnitude is reduced is supplied to the lens control unit 220 so as to move the lens 230 downward. When the lens 230 is positioned within the limit region after the lens 230 is moved, the supplying of the first driving frequency F1 is blocked so as to stop the lens 230 from being moved. Then, the focus of an image is adjusted.

Further, after the target position is set in step S310, and when it is judged in step S320 that the current position of the lens 230 is higher than the target position, the first driving frequency F1 is generated and supplied to the lens control unit 220 so as to move the lens 230 in the downward direction which is the direction for the target position (step S360).

Then, when the current position of the lens 230 is moved to the target position, it is judged whether the lens 230 is positioned within the limit region (step S380). At this time, when it is not judged that the lens 230 is positioned within the limit region, the magnitude of the second driving frequency F2 is reduced so as to reduce the moving speed of the lens 230 such that the lens 230 is re-moved in the reverse direction to the moving direction, and the process is then fed back to step S320.

After that, as the second driving frequency F2 of which the magnitude is reduced is supplied, the lens control unit 220 reduces the moving speed so as to move the lens 230 by a predetermined distance in the reverse direction to the moving direction. Then, the current position of the lens 230 is moved into the limit region, thereby accurately adjusting the focus of an image.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A lens position control device comprising:
a driving frequency generating unit that generates a driving frequency for moving the position of a lens and a driving frequency for reducing the moving speed of the lens to re-move the lens in the reverse direction to the moving direction of the lens after the lens is stopped;
a lens control unit that is connected to the driving frequency generating unit and is driven by the generated driving frequency so as to move the lens; and
a lens position detecting unit that is connected to the driving frequency generating unit and detects the position of the lens to deliver to the driving frequency generating unit.

2. The lens position control device according to claim 1, wherein the driving frequency generating unit includes:
a driving frequency control section which is connected to the lens position detecting unit and generates a control signal for generating the driving frequency; and
a driving frequency generating section which is connected to the driving frequency control section and the lens control unit and is controlled by the control signal output from the driving frequency control section so as to generate a driving frequency.

3. The lens position control device according to claim 2, wherein when the current position of the lens detected by the lens position detecting unit deviates from the target position, to which the lens is to be moved, after the lens is moved, the driving frequency control section outputs a control signal for generating a driving frequency for reducing the moving speed of the lens to re-remove the lens in the reverse direction to the moving direction of the lens.

4. The lens position control device according to claim 3, wherein the driving frequency control section reduces the moving speed of the lens by reducing any one selected from the magnitude of the driving frequency, a duty width, and the frequency.

5. The lens position control device according to claim 4, wherein when the current position of the lens detected by the lens position detecting unit deviates from the target position, the driving frequency control section outputs a control signal for reducing the magnitude of the driving frequency at a ratio selected from 1/2, 1/3, 1/4, and 1/5.

6. A lens position control device for moving a lens, wherein after the lens is moved to a target position where the lens is to be moved, the lens position control device reduces the moving speed of the lens so as to re-move the lens in the reverse direction to the moving direction of the lens.

7. A lens position control method comprising the steps of:
(a) setting a target position to which a lens is to be moved;
(b) judging whether the target position is higher than the current position of the lens or not;
(c) when it is judged that the target position is higher than the current position, generating a driving frequency for moving the lens in an upward direction;
(d) after the lens is moved to the target position, comparing the target position with the current position of the lens;
(e) when the current position is identical to the target position, judging whether the lens is positioned within a preset limit region or not; and
(f) when it is not judged that the lens is positioned within the limit region, generating a driving frequency for reducing the moving speed of the lens such that the process is fed back to step (a) to re-move the position of the lens.

8. The lens position control method according to claim 7, wherein when it is judged in step (b) that the target position is lower than the current position, a driving frequency for moving the lens in the downward direction is generated.

9. The lens position control method according to claim 7, wherein when it is judged in step (d) that the current position is different from the target position, the process is fed back to step (b).

10. The lens position control method according to claim 7, wherein in step (f), the magnitude of the driving frequency, a duty width, or the frequency is reduced so as to reduce the moving speed of the lens.

11. The lens position control method according to claim 7, wherein the magnitude of the driving frequency is reduced at a ratio selected from 1/2, 1/3, 1/4, and 1/5.

12. The lens position control method according to claim 7, wherein when it is judged in step (e) that the lens is positioned within the limit region, the lens is stopped.
